(19) United States
(12) Patent Application Publication
(10) Pub. No.: US 2015/0281278 A1
(43) Pub. Date: Oct. 1, 2015

(54) System For Securing Electric Power Grid Operations From Cyber-Attack

(71) Applicants: Jeff Gooding, Upland, CA (US); Jeremy McDonald, Encinitas, CA (US)

(72) Inventors: Jeff Gooding, Upland, CA (US); Jeremy McDonald, Encinitas, CA (US)

(73) Assignee: SOUTHERN CALIFORNIA EDISON, Rosemead, CA (US)

(21) Appl. No.: 14/228,730

(22) Filed: Mar. 28, 2014

(51) Int. Cl. H04L 29/06

(52) U.S. Cl. CPC H04L 63/20; H04L 63/0218

(57) ABSTRACT

A system for securing electric power grid operations from cyber-attack, the system comprising a collection of security services distributed throughout a smart grid in two main categories of services; central security services and edge security services.

### FIELD OF THE INVENTION

The present invention relates to electric power grid security systems and, more particularly, to a system for securing electric power grid operations from cyber-attack.

### BACKGROUND

With the development of smart grid technologies to modernize the electric grid, vulnerabilities were inherently introduced from using advanced, networked technologies in connection with electric grid operations. While e-commerce grade solutions, designed to support a single vendor's product line, are available they fall short of new requirements that would allow legacy equipment to participate in the smart grid security architecture. Also, there is no solution that provides multi-vendor support and allows for interoperability between devices because they shared a common security system. Additionally, currently available designs that focus on integrating security solutions unique to each vendor's equipment are too complex and expensive to deploy and manage in operations and would threaten grid reliability if not appropriately integrated.

The electric industry has generally avoided the use of modern cyber security and routable protocols instead relying on obscure protocols and serial communications to comply with critical infrastructure regulations and requirements. Recognizing the need for a smarter and more secure grid, the electric industry and federal government have been working on security standards for the grid.

Therefore, there is a need for a system for securing electric power grid operations from cyber-attack that meets Federal Information Processing Standards for the electric grid without the problems inherent in the prior art.

### SUMMARY

The system accomplishes this by providing a method for securing electric power grid operations from cyber-attack using a collection of security services distributed throughout a smart grid comprising two main categories: central security services and edge security services. The central security services integrate security controls and enforcement of security policies through service components deployed centrally at a grid control center and at or near the perimeters of an electric power grid. The central security services are physically located at the grid control center and comprise security management services, cybersecurity infrastructure services, and automated security services.

The security management and configuration services are defined by the common cybersecurity services (CSS) that are distributed throughout the field communications network. In one embodiment the common cybersecurity services are selected from the group consisting of public key infrastructure, group key distribution services and integrity management.

The edge security services are used for security configuration services and automated security services that perform distributed enforcement of security policies at or near the perimeters of an electric grid system. Automated cybersecurity services are used for inherent security services that automatically enforce security policy defined for the common cybersecurity services components deployed at the grid control center or in field devices and are selected from the group consisting of integrity, availability, and confidentiality. The security configuration services are used for support configuration of the security services defined by common cybersecurity services and deployed on the cyber assets as the edge of the field communications network. The automated cybersecurity services are inherent security services that automatically enforce security policy defined for the common cybersecurity services components deployed at the edge using integrity and confidentiality components.

The system also has a security domain, a security perimeter or both a security domain and a security perimeter, where the security perimeter has an electronic security perimeter. The electronic security perimeter is comprised of electronic security domains, logically separated from each other by controlled interfaces, trust relationships, and security associations that are logically separated from each other by controlled interfaces, trust relationships, and security associations. These electronic security domains can be implemented on critical cyber assets. Each domain is segmented by at least one firewall and intrusion detection software and controlled interfaces that comprise a security boundary model. The attributes used to define the security model can be confidentiality, integrity and availability. The security model has non-transitory instructions on a computer readable medium to prioritize security attributes in the following order: (1) availability, (2) integrity, and (3) confidentiality. The availability can be measured in sub-seconds, seconds, minutes, hours, days, weeks and months. The integrity provides assurance that data has not been modified without authorization. The confidentiality provides privacy of customer information, electric market information and general corporate information.

The common cybersecurity services also are made up from non-transitory instructions on a computer readable medium for security controls to interface with external smart grid security domains. The external smart grid security domains can be as broad as the network that connects all grid control centers together across the Western Electric Interchange (i.e. WECCnet or NASPInet), and Public Information Systems. The cyber security infrastructure services are made up from a central security service, a security information repository and a PKI services module. The security information repository module has a security database and an audit log collector. The PKI services performs the following functions: executing and issuing X.509 identity certificates for use in communication authentication; receiving certificate requests from clients; sending certificate responses to clients; and managing and controlling trust anchor updates to all assets. The central security services module also has a security configuration management service module, an integrity service module, a group key distribution service module, and an automated security services module. The security configuration management service has an asset management module for maintaining the electronic serial number association with each cyber asset; managing updates each cyber asset configuration, including upgrades of software or configuration files; and removing Cyber Assets from the network; A policy Management module for managing the creation or alteration of the policies under which the system operates; management and distribution of cyber asset security policies; Role-Based Access Control (RBAC) policy for the cyber asset; electronic access control or monitoring systems policy; and physical access control systems policy; a network management module for managing IP address assignment for each cyber asset; segmentation of the network to minimize compromise; electronic access control systems; and electronic security perimeter gateway policy; and a group management module that manages the creation and deletion of communications groups and assignment or removal of cyber asset into or out of groups; and role management for assigning or changing the role(s) of each cyber asset; security management interface which provides the graphical user interface (GUI) for the security configuration management functions (also called the central security GUI within this document), where the network management module can be an interface to an existing network management system.

The security configuration management service module can be used for configuring the security services provided by the common cybersecurity services and also has asset management for maintaining an electronic serial number association with each cyber asset; managing updates of each cyber asset configuration, including upgrades of software or configuration files; and removing cyber assets from the network. Additionally, the security configuration management service module can be used for policy management for managing the creation or alteration of policies that the system operates; management and distribution of cyber asset security policies; role-based access control (RBAC) policy for cyber assets; electronic access control or monitoring systems policies, and physical access control systems policies. Also, the security configuration management service module performs network management that manages IP address assignment for each cyber asset, segmentation of the network to minimize compromise, electronic access control systems, and electronic security perimeter gateway policies.

The network management module can be an interface to an existing network management system. The security configuration management service module has a graphical user interface, asset management, security policy management, and identification and authentication management.

The security configuration management service module is an integrated tool set with a common integrated security management interface or they can be discrete applications. The asset management module is used for centralized configuration management and change control for all common cybersecurity services registered and controlled cyber assets and to maintain security configuration baselines on all clients, servers, and network devices that have been registered. The central security services module also has a database describing the desired configuration data for each commercial platform that is supported.

The asset management module can be used for vulnerability assessment in order to evaluate all components of the system for security vulnerabilities and for compliance with its maintenance and security policies. The security policy management is an automated policy management tool to create, review and approve policies. The integrity service module is designed to boost integrity, trust and non-repudiation of all cyber assets participating in smart grid applications.

The integrity service module has instructions on a computer readable medium that define requirements for cyber assets to use integrity measurement to prove their integrity to each other and to an integrity management authority. The integrity service module comprises non-transitory instructions on a computer readable medium to interface with cyber assets that are responsible for detection of modifications to their code and configuration, determination of the state of their code and configuration, demonstrating to the integrity service module that their code and configuration are in a known-good state and demonstrating their integrity to each other by presenting a bill of health certificate issued by the integrity service module. The integrity service module 404 stores records for all the registered cyber assets that it has performed attestation with, recording client identity, a timestamp, the result of attestation including reason for failure)if applicable), the Bill of Health serial number if one was issued, and the Bill of Health validity period. The integrity service module 404 uses the Trusted Computing Group Trusted Network Connect standards to perform attestation with the Edge Security Clients.

The group key distribution service module creates and maintains group keys used to secure Internet Key Exchange (IKE) Group Domain of Interpretation (GDOI) messages for multicast communications. The group key distribution service module comprises at least one computer running application level software and a hardware cryptographic module comprises non-transitory instructions on a computer readable medium for cryptographic algorithms. The group key distribution service module has key management primitives to generate, derive and wrap keys; broadcast current key generation messages; respond to group join requests; perform compromise recovery; perform initiated key replacements; and securely wrap keys for storage in a security database.

The automated security services module is used for core cryptographic services and for confidentiality, integrity, authentication, and key management cryptographic services.

There is also provided a method for securing electric power grid operations from cyber-attack by loading the latest operational software image into an intelligent electronic device; loading the intelligent electronic device signed provisioning file, where the loading occurs through the intelligent electronic device's maintenance interface; registration with a field communications services module if the signed X.509v3 certificate was successfully loaded and verified; warehousing the intelligent electronic device at a secure depot for a time frame of six months to a year or more; auditing access control protections and detective controls; and warehousing the intelligent electronic device at a secure depot for a time frame of six months to a year or more.

### BRIEF DESCRIPTION OF THE DRAWINGS

These and other features, aspects and advantages of the present invention will become better understood with regard to the following description, appended claims, and accompanying figures where:

FIG. 1 is a diagram of a system of common cybersecurity services (CCS) according to one embodiment of the present invention;

FIG. 2 is a detailed diagram of electronic security domains implemented on critical cyber assets;

FIG. 3 is a diagram of cyber security infrastructure component modules;

FIG. 4 is a diagram of a central security service sub-components;

FIG. 5 is a diagram of a security information repositories;

FIG. 6 is a diagram of a CCS PKI hierarchy;

FIG. 7 is a diagram of a community of interest key group deployment example (Synchrophasors);

FIG. 8 is a diagram of a security information event management module;

FIG. 9 is a diagram of a edge security services state diagram;

FIG. 10 is a diagram of provisioning an intelligent end device;

FIG. 11 is a diagram of a provisioning Sequence;

FIG. 12 is a diagram of interfaces between a CCS central services and CCS edge security clients; and

FIG. 13 is a diagram of CCS Protocols.

### DETAILED DESCRIPTION

The present invention overcomes the limitations of the prior art by providing a system for securing electric power grid operations from cyber-attack using, in a novel manner, technology solutions used by the Department of Defense and other defense contractors to secure military and intelligence networks.

This common cyber security services (CCS) system described herein is used to secure electric power grid operations from cyber-attack. Specifically, the CCS employs the application of security standards, techniques and designs to provide a common cyber security service that will secure multiple networks, control systems and devices on the power grid in a novel and unique way that has not been accomplished previously. In the past, cyber security, if addressed at all, was deployed as part of a specific vendor solution and would not interoperate or support solutions from different vendors. The present invention supports multi-vendor interoperability in a critical infrastructure environment by virtualization, advanced networking technologies and distributed designs to support electric utility specific protocols as well as standard internet protocols to secure communications and control commands from a control center to devices in the field. Additionally, this invention may be used to secure both the bulk electric transmission system as well as the electric distribution network. While, the key management, cryptographic, and audit services are not unique to this invention, their application to secure the electric grid from cyber-attack coupled with the unique way in which security policies can be applied to devices and key groups to provide a real-time understanding of the grid security posture through the ability to quickly detect, survive and reduce the impact of a security event on electric grid operations is novel and unique.

This invention is a method to secure electric power grid operations from cyber-attack. It is a policy based solution that secures OSI layers three and above through the use of control planes (one for networking, one for security and one for data) and edge devices each cryptographically secured by unique symmetric or asymmetric keys. Policies may be applied to key groups that can be formed in an ad-hoc manner to dynamically change trust boundaries across the system and actively defend the system while it is under attack. While, certificate management, role-based access controls policies and key management are not unique to this invention, their use with a set of policies known as a devices bill of health (BoH) which defines the acceptable behavior of a device in the context of supporting the overall health/reliability of the electric system and quality of trust (QoT) policies which defines how trusted a device is in the electric system at any given time and governs the manner in which other devices in the system treat information and actions from that device are unique as are the application of advanced security technologies to the electric grid. Due to the diverse types of policies, security associations between devices, key group management and real-time monitoring, security mechanisms and policies can be composed as tripwire stacks that would make it very difficult for attackers to compromise the electric grid without detection.

The invention is composed of many commercially available and security standards based solutions, for example PKI, ECC algorithms, standard key management and cryptographic technologies, NETCONF and DDS protocols. However, their application to secure electric industry specific protocols and technologies such as 61850, DNP3, GOOSE, C37.118 that are not typically secured with modern security mechanisms is unique as are the ability to define quality of trust and bill of health policies for devices on the electric grid. Type I software and hardware that supports the National Security Agency's high assurance internet protocol encryption (HAIPE) standard most closely performs similar functions to this invention for defense and intelligence applications but lacks the support to secure electric grid operations and utility industry protocols.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “Electric Power System (EPS)” refers to electrical generation resources, transmission lines, distribution equipment, interconnections with neighboring systems, and associated equipment.

The term “EPS Cyber System Component (ECSC) ” refers to one or more than one programmable electronic devices (including hardware, software and data) organized for the collection, storage, processing, maintenance, use, sharing, communication, disposition, or display of data; which respond to a EPS condition or disturbance; or enable control and operation.

The term “EPS Cyber System (ECS)” refers to one or more than one EPS Cyber System components which if rendered unavailable, degraded, compromised, or misused could, within 15 minutes, cause a disturbance to the EPS, or restrict control and operation of the EPS, or affect situational awareness of the EPS.

The term “EPS Cyber System Application (ECSA)” refers to application software designed to use EPS Cyber System Components to perform specific tasks for a particular purpose, i.e. DMS, ALCS, WASAS, A&V, CCS, etc.

The term “Edge Security Client” refers to an EPS Cyber Systems Component (ECSC) capable of providing distributed enforcement of security policy at or near the perimeter of the system; also referred to as the “Client”.

The term “Centralized Remedial Action Scheme (C-RAS)” refers to a Centralized Remedial Action Schemes (C-RAS) that combines all RAS's into a single, shared platform. This platform provides visualization of system-wide conditions (status of various RASs, general grid condition, generation outputs, etc) such that the calculation of real-time mitigation strategies allows C-RAS to optimize and coordinate the various RASs. C-RAS is faster than existing RASs since it communicates over a high speed, broadband wide area network. C-RAS also uses a logic processor that can handle a virtually unlimited number of contingency scenarios, whereas existing RAS logic processors are limited to twenty-four processors.

The term “Commissioning” refers to the process where a device obtains access to a specific physical network and allows the device to be discovered on that network.

The term “Energy Management System (EMS)” refers to a system of tools used by system operators to monitor, control, and optimize the performance of the transmission system. The monitor and control functions are performed through the SCADA network. Optimization is performed through various EMS applications.

The term “Enterprise Asset Management System (EAMS)” refers to the module or modules of the Enterprise Resource Planning system concerned with storing and updating information regarding utility assets. This keeps track of every asset in the enterprise including all trouble reports, installation information, manufacturer, information gathered by field personnel, etc. This is used to establish baselines on individual assets and classes of assets, and to track these assets to compare against the baselines. This system also contains a suite of analysis tools, decision support functions, dashboard, etc.

The term “Flexible AC Transmission System Device (FACTS device)” refers to control devices characterized by solid state switching, fast action (within 2 cycles), and customized controls. Different devices have different modes of operation to perform different tasks. Static VAR compensators are one type of FACTS device that provide voltage support. Other FACTS devices assist with power flow control and phase shifting.

The term “Key Agreement” refers to a key establishment procedure where the resultant secret keying material is a function of information contributed by two participants, so that no party can predetermine the value of the secret keying material independently from the contributions of the other party. Contrast with key transport.

The term “Key Transport” refers to a key establishment procedure whereby one party (the sender) selects a value for the secret keying material and then securely distributes that value to another party (the receiver). Contrast with key agreement.

The term “Phasor Data Concentrator (PDC)” refers to a device that collects and aggregates phasor data from multiple Phasor Measurement Units (PMU) and relays the data to the Predictive Grid Control System.

The term “Phasor Measurement Unit (PMU)” refers to devices capable of measuring voltage and current sinusoidal waveforms on transmission lines, and transmitting the data to the utility for monitoring and control purposes. The data consists of phase angles, frequency, and electrical parameters (voltage, current, real power and reactive power). The data is accurately time-stamped to IEEE standards, and is capable of being transmitted to the Predictive Grid Control System within 100 milliseconds. A PMU can be a stand-alone physical unit or a functional unit within another physical unit.

The term “Predictive Grid Control System (PGCS)” refers to a system that receives data from Phasor Measurement Units (PMU) and other sensor devices, determines that stability control is needed, calculates the optimal strategy, and communicates that strategy to FACTS devices. PGCS is a hypothetical future system that can perform this function. This system is currently undefined. It could be a next generation Energy Management System. Likewise, it may be either centralized or distributed. The system architecture will be determined after a more detailed analysis of the system requirements.

The term “Registration” refers to a process where a Commissioned device is authorized to communicate on a logical network by exchanging security credentials with an CSI

The term “Enrollment” refers to the process by which a Consumer enrolls a Registered HAN device in a Service Provider program (e.g. demand response, energy management, PEV program, etc.)

The term “Symmetric authentication key” refers to symmetric authentication keys are used with symmetric key algorithms to provide assurance of the integrity and source of messages, communication sessions, or stored data.

The term “Symmetric data encryption key” refers to keys that are used with symmetric key algorithms to apply confidentiality protection to information.

The term “Symmetric key wrapping key” refers to symmetric key wrapping keys that are used to encrypt other keys using symmetric key algorithms. Key wrapping keys are also known as key encrypting keys.

Various embodiments provide a system for securing electric power grid operations from cyber-attack that meets Federal Information Processing Standards. The system will now be disclosed in detail.

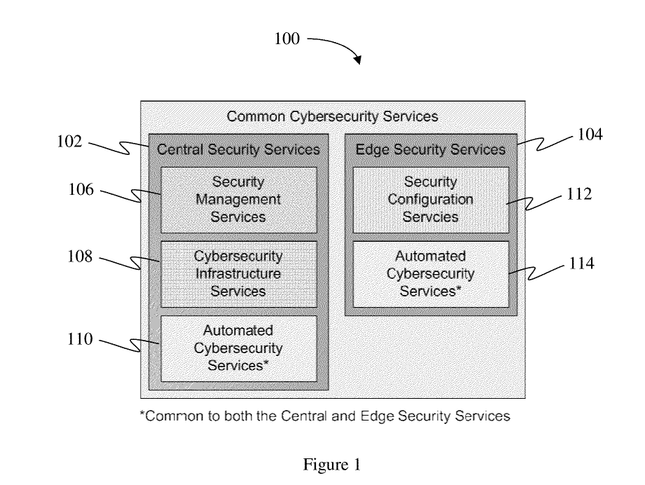

Referring now to FIG. 1, there is shown a diagram of a system 100 of common cybersecurity services (CCS) according to one embodiment of the present invention. As can be seen, the system of common cybersecurity services (CCS) 100 is a collection of security services that are distributed throughout a smart grid implementation in two main categories, central security services (Central) 102 and edge security services 104. The CSS 100 integrates security controls and enforcement of security policies through service components that are deployed centrally (at a grid control center) and at or near the perimeters of a system as described below. The owner/operators are responsible for providing the field communications equipment (routers, switches, fiber optics, etc.) that support communications between these Central and Edge security services.

The central security services (Central) 102 provides security management services 106, cybersecurity infrastructure services 108 and automated security services 110 that are physically located at the grid control center. Security management services 106 provide for management and configuration of the security services defined by CCS 100 and distributed throughout the field communications network. Cybersecurity infrastructure services 108 provide security infrastructure services defined by the CCS 100, i.e. public key infrastructure, group key distribution services, integrity management, etc. Automated cybersecurity services 110 provide inherent security services that automatically enforce security policy defined for the CCS 100 components deployed at the grid control center (GCC) 204, i.e. integrity, availability, and confidentiality.

Edge security services 104 provide security configuration services 112 and automated security services 114 that perform distributed enforcement of security policies at or near the perimeters of an electric grid system. Security configuration services 112 support configuration of the security services defined by CCS and deployed on the cyber assets as the edge of the field communications network. Automated cybersecurity services 114 provide the inherent security services that automatically enforce security policy defined for the CCS components deployed at the edge, i.e. Integrity, and Confidentiality.

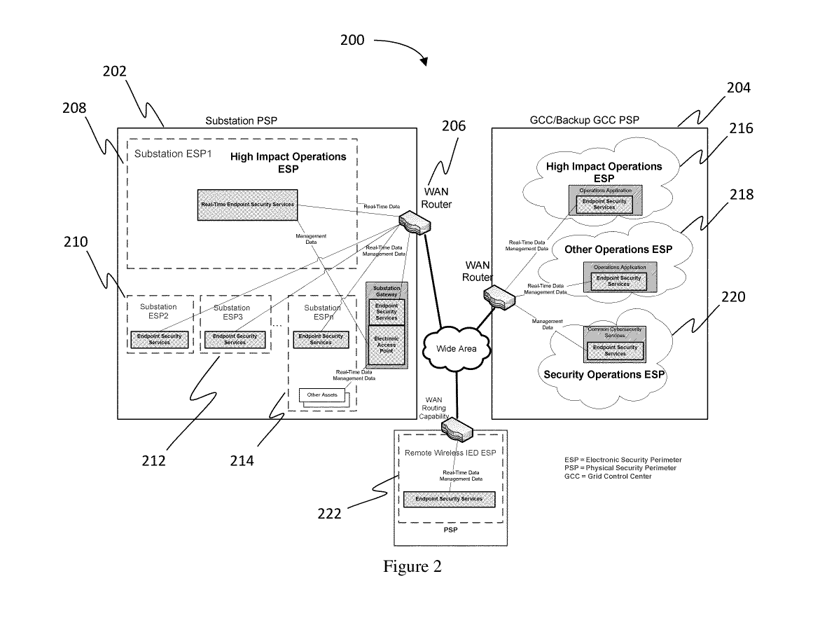

Referring now to FIG. 2, there is shown a detailed diagram of electronic security domains implemented on critical cyber assets (CCA) 200. Of critical importance to the security architecture are the concepts of security domains and perimeters. Security mechanisms are necessary to support communications across the security perimeters and security domains. Security perimeters and security domains provide the capability of defining security requirements that are unique to the implementation environment and communication requirements of each security perimeter and domain, as well as address the interactions and interdependencies with other enterprise and business applications encapsulated within the security perimeters. The system-of-systems security requirements for deploying services and components using secure communications between and among central and edge components. Substation physical security perimeters (PSP) 202 and grid control center (GCC) 204 physical security perimeters (PSP) 204 are shown as part of the electronic security domains 200. Within the PSPs 202 and 204 there are electronic security perimeters (ESP) 208, 210, 212 and 214. Within ESPs are various electronic security domains (or communities of interest) that are logically separated from each other by controlled interfaces, trust relationships, and security associations. Electronic security domains are implemented on critical cyber assets (CCA) 200.

The security requirements for communications between the components of the security perimeters 202 and 204 and the systems external to the security domain (i.e., Western Electricity Coordinating Council (WECC), NASPInet and Public Information Systems) are addressed at a higher level.

As can be seen, the components are deployed at substations and grid control centers (GCC) that have physical security perimeters (PSP) 202 and 204. Within the PSPs 202 and 204 there are electronic security perimeters (ESP) 216, 218 and 220, enforced by the common cyber security services (CCS) 100 components. The ESPs 216, 218 and 220 comprise various electronic security domains (or communities of interest) that are logically separated from each other by controlled interfaces, trust relationships, and security associations.

The CCS 100 security model provides the framework for defining the system security architecture and security policy for each domain. Each domain is segmented by firewalls and intrusion detection software 206 native to the CCS edge services and other controlled interfaces. The primary attributes used to define the security model are:

Confidentiality: Prevention of unauthorized disclosure of data

Integrity: Detection of unauthorized modification of data

Availability: Minimize the loss of access to resources and data

Traditional security models enforce multilevel security policy for protection of confidentiality, such as the Bell-LaPadula model. Other models enforce rules to protect integrity, such as the Biba model. Within the CCS 100 operations domain, the security model prioritizes security attributes in the following order: (1) availability, (2) integrity, and (3) confidentiality. Power system security models stress availability as paramount which differs from typical security models that look to enforce confidentiality and integrity above availability.

Grid security policies drive the following design rules and guidance in implementing CCS 100 components on the electric grid:

Field devices should be designed to boost integrity, trust and non-repudiation;

Field devices must detect and report internal integrity failures (detected within themselves or reported by peers) to CCS central services;

Grid Protection Application traffic flow to and from field devices (commands and data, i.e. control loops) should not be halted or blocked by CCS;

Grid Protection Applications that consume data from remote field devices that are classified as untrusted by CCS should have a policy to handle the untrusted data;

Grid Protection Applications (i.e. control loops) must be designed to work around untrusted data and untrusted field devices;

Distributed CCS components must continue to operate when central services are unreachable;

Field devices must prove their integrity to each other without access to a central verification point;

Field devices must process authorization attributes from each other without access to a central decision point;

Authentication and authorization credentials and cryptographic keys in operational use are retained on field devices and used past the expiration date if necessary until central services can be reached.

Security Model

A security model provides the framework for defining the system security architecture and security policy for each domain. There are two CCS Security Domains addressed in this Cybersecurity Reference Design: Operations and Enterprise. Each domain is segmented by firewalls and other controlled interfaces.

The primary attributes used to define the security model are:

Confidentiality: Prevention of unauthorized disclosure of data

Integrity: Detection of unauthorized modification of data

Availability: Minimize the loss of access to resources and data

The following paragraphs identify the level of security applied to confidentiality, integrity and availability as specified in NISTIR 7628. According to NISTIR 7628:

Availability is the most important security objective for power system reliability. The time latency associated with availability can vary:
Subseconds for transmission wide-area situational awareness monitoring (30, 60, 120 Hz);
Seconds for substation and feeder supervisory control and data acquisition (SCADA) data;
Minutes for monitoring noncritical equipment and some market pricing information;
Hours for meter reading and longer-term market pricing information; and
Days/weeks/months for collecting long-term data such as power quality information.
Integrity for power system operations to provide assurance that data has not been modified without authorization;
Source of data is authenticated;
Time stamp associated with the data is known and authenticated; and
Quality of data is known and authenticated.

Confidentiality is the least critical for power system reliability. However, confidentiality is becoming more important, particularly with the increasing availability of customer information online:
Privacy of customer information;
Electric market information; and
General corporate information, such as payroll, internal strategic planning, etc.

In the context of CCS 100 operations domain, confidentiality plays a lesser role in that the interfaces supporting information exchange fall into logical interface category 1. Per the NISTIR, impact levels on confidentiality, integrity, and availability are used in the selection of security requirements for each logical interface category. For logical interface category 1, the NISTIR assesses the impact of a security compromise on confidentiality as low, on integrity as high, and on availability as high.

Grid Protection Security Policy

The security policy for smart grid protection drives the following design rules and guidance:
Field devices should be designed to boost integrity, trust and non-repudiation;
Field devices must detect and report internal integrity failures (detected within themselves or reported by peers) to CCS 100;
Grid protection application traffic flow to and from field devices (commands and data, i.e. control loops) should not be halted or blocked by CCS 100;
Grid protection applications that consume data from remote field devices that are classified as untrusted by CCS 100 can comprise a policy to handle the untrusted data;
Grid Protection Applications (i.e. control loops) must be designed to work around untrusted data and untrusted field devices;
Distributed CCS 100 components must continue to operate when central services are unreachable;
Field devices must prove their integrity to each other without access to a central verification point;
Field devices must process authorization attributes from each other without access to a central decision point;
Authentication and authorization credentials and cryptographic keys in operational use are retained on field devices and used past the expiration date if necessary until central services can be reached;

Smart Grid Security Domains

The Internet Security Glossary RFC2828 defines a security domain as “An environment or context that is defined by a security policy, security model, or security architecture to include a set of system resources and the set of system entities that have the right to access the resources.”

Additionally, security domains can be defined as the people, data systems, and devices that must comply with an organization's security policy.

There also needs to be a network policy that defines the network boundary that in turn affects the definition of the security domain.

CCS 100 provides security controls necessary to interface with three external “Smart Grid” Security Domains: WECCnet, NASPInet, and Public Information Systems.

There are typically two security domains: an Operations domain and an Enterprise domain. Each domain is segmented by firewalls and other controlled interfaces.

The Operations domain includes real-time latency-critical data exchange to facilitate control decisions that ensure the stability of the Smart Grid. It includes both transmission and distribution substations.

The Enterprise domain is responsible for billing, accounting, marketing and other non-real-time SCE activities. It does not access or control substation equipment.

Security Perimeters

The Internet Security Glossary RFC2828 defines security perimeter as “The boundary of the domain in which security policy or security architecture applies; i.e., the boundary of the space in which security services protect system resources.” In other words, a security perimeter is a boundary that divides the trusted from the untrusted components. As defined by NERC CIP, Security Perimeters can be either Electronic Security Perimeters (ESPs) or Physical Security Perimeters (PSPs).

Electronic Security Perimeters

The North American Electric Reliability Corporation (NERC) defines an Electronic Security Perimeter as the logical border surrounding a network to which Bulk Electric System (BES) Cyber Systems are connected using a routable protocol. Per NERC, the Responsible Entity identifies BES Cyber Systems and associated ESPs as a separate activity. The notional ESPs identified in this document are not intended to be a complete set nor are they intended to be an accurate representation of an implementation.

The ESP defines a zone of protection around the BES Cyber System, and it also provides clarity for entities to determine what systems or Cyber Assets are in scope and what requirements they must meet. The ESP is used in:
Defining the scope of ‘Associated Protected Cyber Assets’ that must also meet certain CIP requirements.
Defining the boundary in which all of the Cyber Assets must meet the requirements of the highest impact BES Cyber System that is in the zone (the ‘high water mark’).

One of the most challenging new security threats to the SmartGrid is the targeted insertion of malware inside the Electronic Security Perimeter (ESP) of a substation. The Stuxnet attack on nuclear control devices is an example of this threat. Because of these new threats, a new class of countermeasures are required that are not addressed by current NERC CIP requirements, which focus on external boundary protection measures and secured access to substation facilities. Current ESP requirements provide very little protection from threats that arise from within the ESP. New CCS 100 countermeasures follow the “zero-trust” model, which incorporates the defense-in-depth principle. The defense-in-depth principle keeps the security functions of ESP boundary protection devices and adds additional security functions to each of the field devices for self-protection. In addition, the patterns of activity within a substation are monitored by audit and reporting functions that are customized for the Smart Grid application environment.

Physical Security Perimeters (PSP)

Per NERC CIP, the Physical Security Perimeter is the physical border surrounding locations in which BES Cyber Assets, BES Cyber Systems, or Electronic Access Control or Monitoring Systems reside, and for which access is controlled.

Where a completely enclosed (“six-wall”) border cannot be established, alternative measures to control physical access to such Cyber Assets must be in place.

The Cybersecurity Reference Design assumes that some Protected Cyber Assets (PCAs) will not be enclosed within a “six wall” PSP; therefore, these PCAs should provide the physical security mechanisms defined for FIPS 140-2 Level 3, which require physical tamper-resistance and identity-based authentication.

In the case of CCS 100, the physical security mechanisms required at Security Level 3 are meant to provide a high probability of detecting and responding to attempts at physical access, use or modification of Cyber Assets.

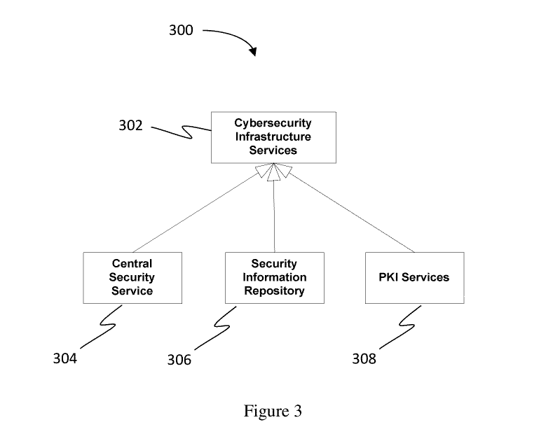

Referring now to FIG. 3, there is shown a diagram of cyber security infrastructure services sub component modules 300. The main sub component modules of the cyber security infrastructure services are a central security service 304, a security information repository 306 and PKI services 308. The security information repository 306 comprises modules include a CCS security database and a CCS audit log collector. The PKI Services 308 comprise instructions for executing and issuing all X.509 identity certificates for use in communication authentication, receiving certificate requests from clients; sending certificate responses to clients; and managing and controlling trust anchor updates to all assets.

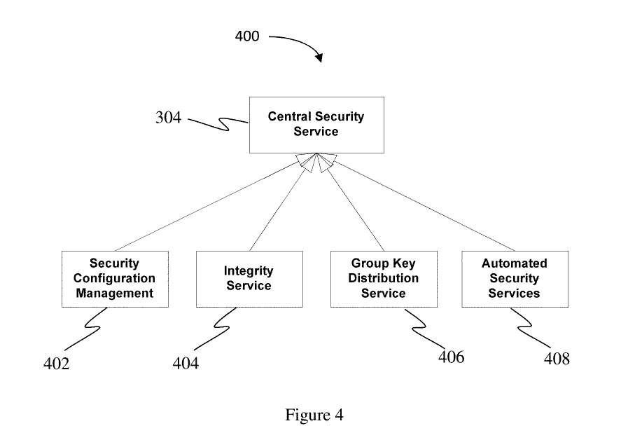

Referring now to Referring now to FIG. 4, there is shown a diagram 400 of central security service (CSS) 304 sub-components 400. The CSS 304 comprises a security configuration management service module 402, an integrity service module 404, a group key distribution service 406 and automated security services 408.

The security configuration management service module 402 comprises the following:
An asset (client) management module for maintaining the electronic serial number association with each cyber asset; managing updates each cyber asset configuration, including upgrades of software or configuration files; and removing Cyber Assets from the network;
Policy Management for managing the creation or alteration of the policies under which the system operates; management and distribution of cyber asset security policies; Role-Based Access Control (RBAC) policy for the cyber asset; electronic access control or monitoring systems policy; and physical access control systems policy;
Network Management (may be an interface to an existing network management system) for managing IP address assignment for each cyber asset; segmentation of the network to minimize compromise; electronic access control systems; and electronic security perimeter gateway policy;
Group Management which is responsible managing the creation and deletion of communications groups and assignment or removal of cyber asset into or out of groups;
Role management for assigning or changing the role(s) of each cyber asset; security management interface which provides the graphical user interface (GUI) for the security configuration management functions (also called the central security GUI within this document).

The security configuration management service module 402 is responsible for configuration of the security services provided by the CCS 100 and comprises instructions for an asset (client) management that maintains an electronic serial number association with each cyber asset; managing updates of each cyber asset configuration, including upgrades of software or configuration files; and removing cyber assets from the network. Additionally, the security configuration management service module 402 comprises instructions for policy management that manages the creation or alteration of the policies under which the system operates; management and distribution of cyber asset security policies; role-based access control (RBAC) policy for cyber assets; electronic access control or monitoring systems policies, and physical access control systems policies. The security configuration management service module 402 further comprises instructions for network management that manage IP address assignment for each cyber asset, segmentation of the network to minimize compromise, electronic access control systems, and electronic security perimeter gateway policies. Optionally the network management can be an interface to an existing network management system. The security configuration management service module 402 provides instruction for a Graphical User Interface (GUI) for the security configuration management service module 402 functions.

As can be appreciated, the security configuration management service module 402 comprises a broad range of services including asset management, security policy management, and identification and authentication management. Ideally, these functions would be implemented using an integrated tool set with a common integrated security management interface. However, they can be optionally implemented using discrete applications. Each of the discrete applications will now be discussed.

The Asset Management function provides centralized configuration management and change control for all CCS 100 registered and controlled cyber assets. It maintains security configuration baselines on all clients, servers, and network devices that have been registered. Given that many CCS 100 components will operate on platforms upon which commercial software is installed, it is essential that these components are configured with the most recent software upgrades and configuration setting guidelines. This requires that the CSS 100 maintain a database describing the desired configuration data for each commercial platform that is supported. Government networks currently require system configuration scans that are often performed under human supervision with a period between scans measured in months. A number of security software vendors now offer agent-based configuration monitoring systems that provide continuous monitoring of configuration changes with online reporting to the equivalent of a CSS 100 policy enforcement server. Each supported platform hosts a software agent that is installed at boot time that monitors the device during execution. In some cases automated isolation of offending systems to a quarantine network environment is supported. Asset Management includes vulnerability assessment capabilities in order to evaluate all components of the system for security vulnerabilities and for compliance with its maintenance and security policies. All components of the system are updated or replaced to address identified vulnerabilities or non-compliance issues in accordance with the maintenance policy and procedures.

Security Policy Management provides a consistent and automated policy management tools to create, review and approve policies. It includes built-in knowledge of security regulations and compliance requirements.

Identification and Authentication Management define the policies and processes needed to uniquely identify and authenticate users (or processes acting on behalf of a user) to the system or system component. User identification and authentication may be role-based, group-based, or device-based.

Authentication of user identities shall be accomplished through the use of passwords, tokens, biometrics, or in the case of multi-factor authentication, some combination of these. Remote user access to system components such as CCS Clients can only be enabled when necessary, approved, and protected.

The integrity service module 404 is designed to boost integrity, trust and non-repudiation of all cyber assets participating in smart grid applications. The integrity service module 404 defines requirements for cyber assets to use integrity measurement (metrics) to prove their integrity to each other and to an Integrity Management Authority (IMA). Within the context of CCS 100, cyber assets detect and report internal integrity failures (detected within themselves or reported by peers) to the IMA. The integrity of the smart grid is maintained through the use of the Trusted Computing Group's Trusted Network Connect (TNC).

A fundamental requirement for the integrity service module 404 is that traffic flow to and from cyber assets (commands and data or control loops) should not be halted or blocked by CCS 100 due to an integrity failure. BES cyber systems that consume data from remote Cyber Assets that are considered untrusted must mark that data as untrusted during processing, visualization, and storage and must be robust enough to survive in the presence of untrusted data or Cyber Assets.

The integrity service module 404 interfaces with cyber assets that are responsible for detection of modifications to their code and configuration, determination of the state of their code and configuration, demonstrating to the integrity service module 404 that their code and configuration are in a known-good state and demonstrating their integrity to each other by presenting their Bill of Health Certificate issued by the integrity service module 404.

The integrity service module 404 stores records for all the registered cyber assets that it has performed attestation with, recording client identity, a timestamp, the result of attestation including reason for failure)if applicable), the Bill of Health serial number if one was issued, and the Bill of Health validity period. The integrity service module 404 uses the Trusted Computing Group Trusted Network Connect standards to perform attestation with the Edge Security Clients.

The group key distribution service 406 provides instructions for creating and maintaining the group keys used to secure Internet Key Exchange (IKE) Group Domain of Interpretation (GDOI) messages for multicast communications. The group key distribution service 406 is a major service of CCS 100 and is typically located at the GCC. The group key distribution service 406 comprises at least one computer running application level software and a hardware cryptographic module executing the cryptographic algorithms. The group key distribution service 406 anchors group key management for field communications networks.

The group key distribution service 406 utilizes key management primitives to:

1. Generate/derive and wrap keys,

2. Broadcast current key generation messages,

3. Respond to group join requests,

4. Perform compromise recovery,

5. Perform initiated key replacements, and

6. Securely wrap keys for storage in a Security Database.

The group key distribution service 406 can be deployed on off-the-shelf standalone computers, with one or more FIPS 140-2 validated hardware cryptographic modules. The group key distribution service 406 application level software communicates with the hardware cryptographic module using a crypto API via a locally attached connection (e.g., Ethernet) if the module is external, or PCI/PCI-X/PCI-E based card. This lets the group key distribution service 406 owner replace the hardware cryptographic module with any cryptographic module that supports the same Application Programming Interface (API).

The automated security services 408 provide core cryptographic services needed to meet security policy for CCS 100 capable cyber assets. The automated security services 408 require no human intervention once configured and are built for speed and efficiency. The automated security services 408 include confidentiality, integrity, authentication, and key management cryptographic services.

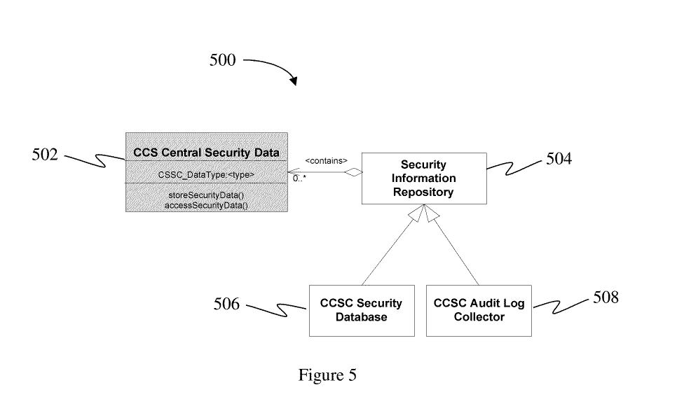

Referring now to FIG. 5, there is shown a diagram of security information repositories 500. The security information repositories 500 comprise a CCS central (CCSC) security database 506 and a CCSC audit log collector 508. The CCSC security database 506 stores keys wrapped by a CCSC key server, PKI tracking information, CCS device tracking information, identity management data, and security-relevant fault-management, configuration, accounting, performance, and security (FCAPS) information. The CCSC security database 506 does not communicate directly with CCS edge security client devices or services, nor does it contain application data. The CCSC audit log collector 508 is a separate unstructured database required to support Security Information and Event Management (SIEM) data.

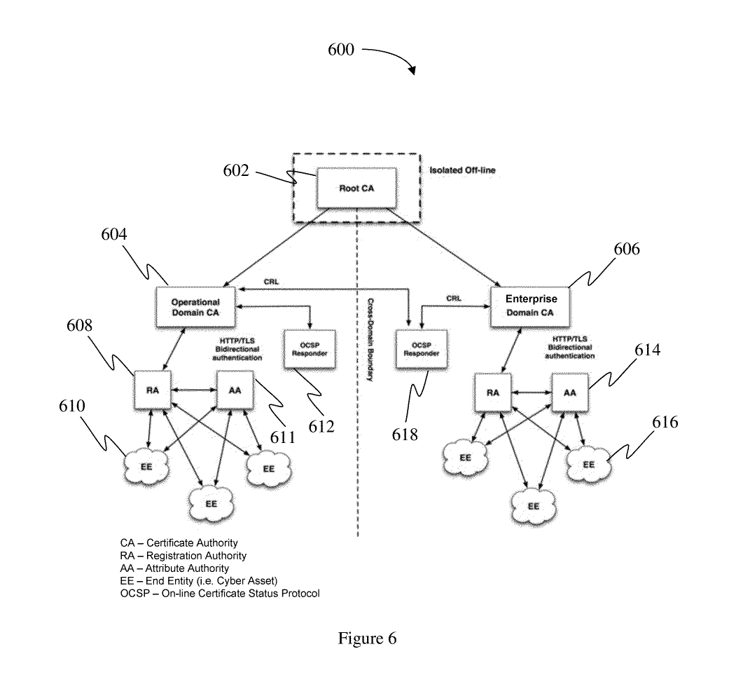

Referring now to FIG. 6, there is shown a diagram of a CCS public key infrastructure (PKI) service 600 hierarchy. The PKI service 600 comprises instructions that provide X509v3 certificates for the CCS 100. Various types of certificates can be used for authentication, secure communications establishment, and bill of health attestation by both services and clients. Entities trust the communication or information based on the trust of the signer of the certificate, also known as a trust anchor. Certificates have a lifetime commensurate with their type of use. Because of certificate expiration, all certificates have to be renewed periodically by the certificate holder. Trust of a certificate can be removed by the revocation process. All relying users of certificates (clients and services) must verify the certificate is not revoked, not expired and signed by the expected trust anchor prior to trusting the transaction (connection or data).

The PKI service 600 comprises components that can be provided by the Common Cybersecurity Services 100. A root certificate authority (CA) 602 is the top of the certificate hierarchy, and is the only self-signed certificate in the infrastructure. The CA's 602 primary purpose is to certify subordinate CAs as they are needed within the PKI service 600 hierarchy.

Operational and administrative domain CAs 604 are subordinate CAs that comprise instructions to handle day-to-day certificate issuance and revocation actions of end entities 610. Operational and administrative domain CAs 604 are network accessible to a limited degree with the caveat that end entities 610 are not able to access the CAs 604 directly. Instead, end entities 610 will make use of a registration authority 608 (RA) that can communicate with the operational and administrative domain 604 CAs. The operational and administrative domain 604 CA can also sign code for clients. This provides one of the Integrity Service checks performed periodically on Clients

A central security registration authority 612 is a registration authority (RA) in the PKI service 600 hierarchy that can verify requests for a digital certificate and can request the certificate authority 604 (CA) to issue it. RAs are part of the public key infrastructure (PKI) service 600 that enables companies and users to exchange information safely and securely in a networked system. The digital certificate contains a public key that is used to encrypt and decrypt messages and digital signatures.

Integrity management authority is an attribute authority 611 (AA) that can perform all Bill of Health certificate creation for Clients. Bill of Health Attribute Certificates hold a single statement of integrity.

An online certificate status protocol (OCSP) responder 612 is an Internet protocol used for obtaining the revocation status of an X.509v3 digital certificate. It is described in RFC 2560 and is on the Internet standards track. Messages communicated via OCSP 612 are encoded in Abstract Syntax Notation One (ASN.1) and are usually communicated over HTTPS.

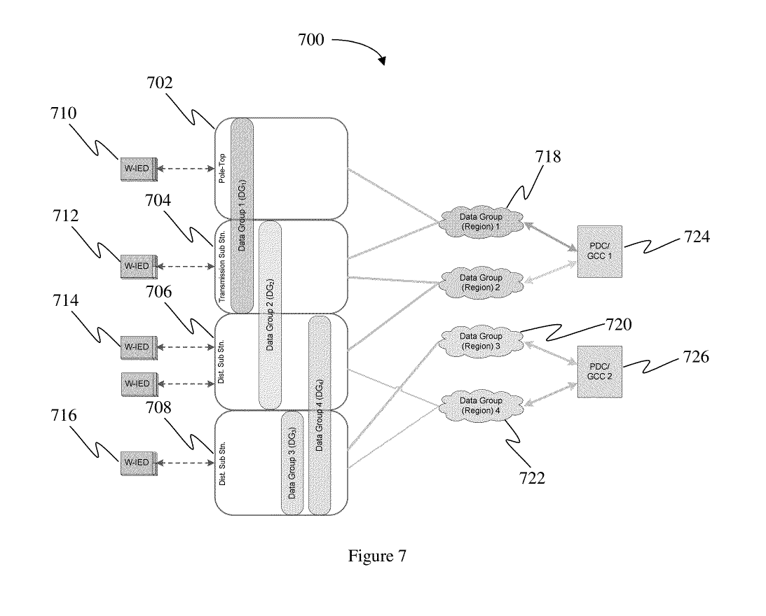

Referring now to FIG. 7, there is shown a diagram of a community of interest key group deployment 700. Data groups of interest (GDOI) policies are maintained by the CCS 100 form cryptographic groups called data groups. Data groups are used to protect communication of PMU commands, PMU status, and PMU data between cyber assets (i.e., PMUs, PDCs) and applications that are members of a specific BES Cyber System. Data Groups communities of interest (COI) is defined by the GDOI policy that they share.

Synchrophasor commands and data are sent through the Field Communications Network within the data groups. Edge security clients (aka Clients) can be commissioned into data groups so that a balance is struck between minimizing peer-to-peer interaction between clients of different groups (tends toward making larger groups) and minimizing the number of clients in any one group (tends toward making smaller groups). More cross-group peer relationships require more peers to be in multiple groups, which places more risk of key compromise in the peer clients IEDs. Larger groups require a longer compromise recovery re-key process.

Group boundaries can be organized such that a GDOI group compromise that leads to a smart grid control compromise or outage can be isolated to one physical section of the smart grid. Additionally, Data Groups can be used to improve availability by distributing a COI across different substations.

Specification IEC 61850-90-5 specifies that there is only one PMU IED transmitting data within each DGi group. Because of this limitation on architecture the 61850-90-5 specification allows a PMU IED to become the GDOI GKDC the group it is transmitting into. IEDs such as Phasor Data Concentrators, Phasor Data Gateways, and other IEDs that need to receive data from the PMU must join that PMU's group as group members.

The Field Communications Networks Key Management complies with SP 800-57 Part 1 and RFC 6054 (Modes for AES Protection of Group Traffic). It is recommended that the Field Communications Network Key Management comply with RFC 3547 (GDOI) including the LKH extensions and also with IEC 61850-90-5. The decision to use 61850-90-5 style group key management or GDOI style group key management can be made at time of deployment and should be based on a trade-off judgment of the need versus the risk of performing group key management inside substations (greater local availability) vs. performing group key management in the GCC (greater assurance). This decision can be made per DGi group if need be.

For each PMU IED that implements the Field Communications Network Key Management with IEC 61850-90-5 style key management on-board the PMU IED, it must also comply with NIST SP800-90 entropy sources and random number generation guidance.

RFC 6054—Modes For IPSec Protection of Group Traffic

Several new AES encryption modes of operation have been specified for Encapsulated Security Protocol (ESP): Counter Mode (CTR) [RFC3686], Galois/Counter Mode (GCM) [RFC4106], and Counter with Cipher Block Chaining-Message Authentication Code (CBC-MAC) Mode (CCM) [RFC4309]; and one that has been specified for both ESP and AH: the Galois Message Authentication Code (GMAC) [RFC4543]. A Camellia counter mode [RFC5528] and a GOST counter mode [RFC4357] has also been specified. These new modes offer advantages over traditional modes of operation. However, they all have restrictions on their use in situations in which multiple senders are protecting traffic using the same key. This RFC document addresses this restriction and describes how these modes can be used with group key management protocols such as the Group Domain of Interpretation (GDOI) protocol [RFC3547] and the Group Secure Association Key Management Protocol (GSAKMP) [RFC4535].

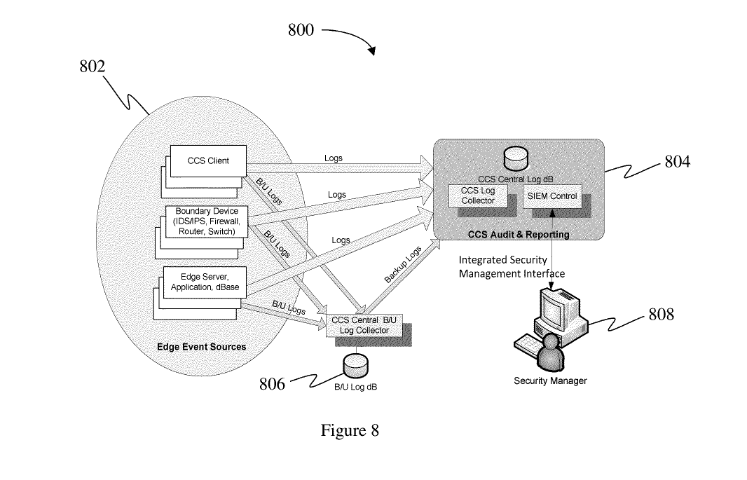

Referring now to FIG. 8, there is shown a diagram of a security information event management module 800. The security Information and event management (SIEM) module 800 provides collection of edge event sources 802 for alerting and analysis of log data 804 enabling security managers 808 to simplify compliance and quickly respond to high-risk security events. The SIEM module 800 is capable of collecting and analyzing large amounts of data in real-time from any event source 802 in a CS and provides secure, forensically sound storage and archival of event logs 806. The SIEM module 800 can provide content-aware event analysis and correlation tools and can relate events which occur on multiple systems. Reporting tools 804 mine the logs for useful information. Additionally, the SIEM module 800 can be used as a tool to optimize network performance by providing network availability and status, identifying network issues and faulty equipment, and gaining visibility into specific behavioral aspects of users.

The SIEM module 800 can also provide behavioral analysis. Behavioral analysis can support near-real-time automated analysis of event patterns and sequences. For example, a correlation of events involving a single authenticated client can be used to determine the physical and/or logical network location of events. If audited events are spread out over multiple such locations within a short period of time, an alert can be issued and possible remediation actions taken, such as, for example, cryptographic compromise recovery that invalidates the working keys of a suspect entity.

The SIEM module 800 can also collect logs from IEDs and other field or central devices, routers, switches, firewalls, IPS/IDS systems, servers, hosts, and applications.

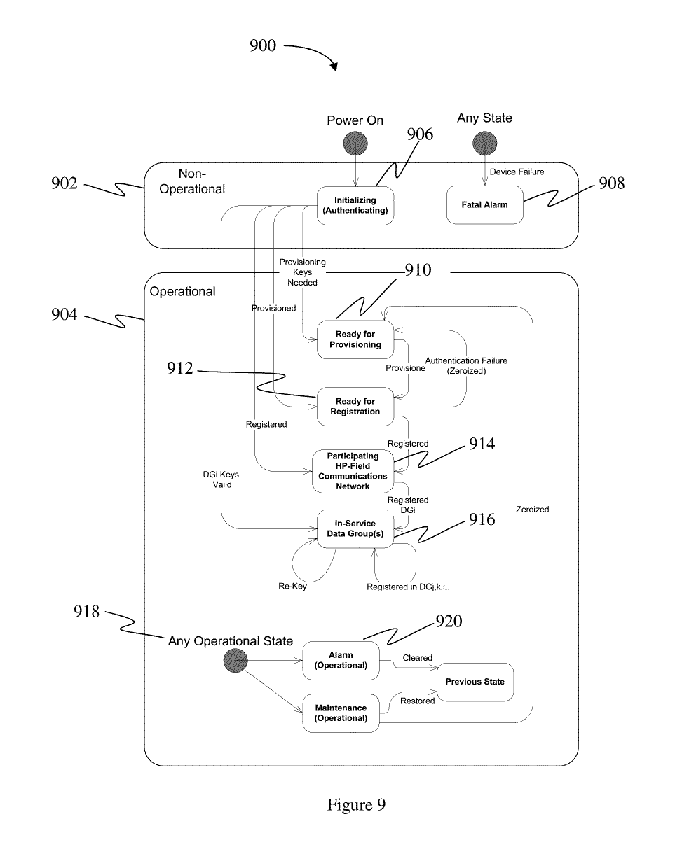

Referring now to FIG. 9, there is shown a diagram of an edge security services state diagram 900. As can be seen, an edge security client has two primary states: operational 904 and non-operational 902.

Edge Security Client Non-Operational States

There are two edge security client non-operational sub-states 906 and 908. When the edge security client is powered on 906, it will go into an initializing state during which the edge security client can perform self-tests and either transition into one of the operational 904 sub-states or transition into non-operational fatal alarm state 908 indicating the device cannot be put into service. Additionally, the edge security client can transition into the fatal alarm state 908 from any other state.

Edge Security Client Operational States

If the edge security client has the provisioning PKI credentials, it will transition into a ready for provisioning state 910. If the edge security client is successfully provisioned with operational credentials, it will enter a ready for registration state 912. If the edge security client has one or more valid COI Data Group GDOI SA TEKs (RFC 3547) 914 it will transition into an in-service state 916. The edge security client can enter or leave Data Groups 916 without impacting data flow within other groups. Periodic re-keying events will not require taking the edge security client out of service or halting any data flows. The edge security client enters an alarm state 920 as a result of certain alert conditions such as detection of tamper events or other integrity failures. When such failures occur, the edge security client will continue to process phasor data but update the quality of trust to “untrusted” until the alarm state 920 is cleared. The PDC will also mark the phasor data from an edge security client in the alarm state 920 as untrusted.

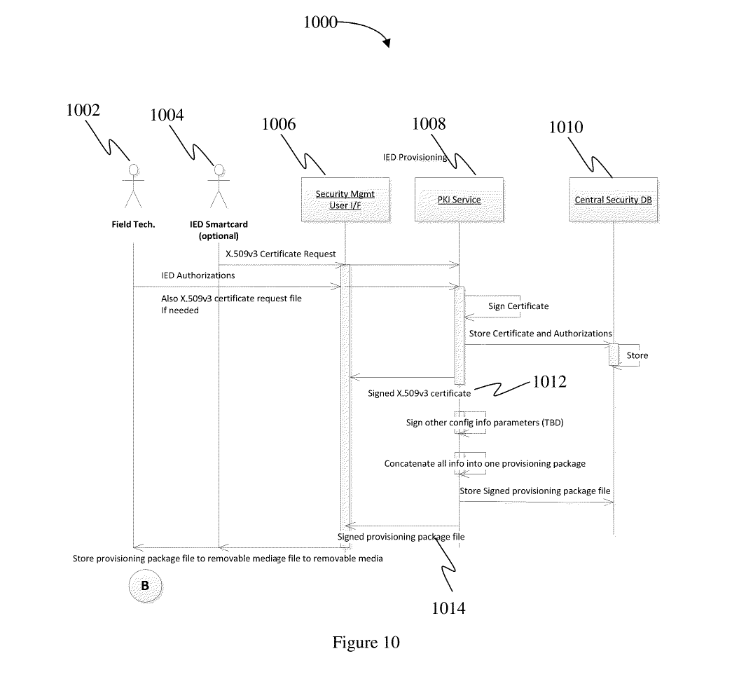

Referring now to FIG. 10, there is shown a diagram of provisioning an intelligent end device 1000. Provisioning an intelligent end device comprises a central security database 1010, a PKI service module 1008 and a security management module and user interface 1006. The CCS 100 controls the overall intelligent electronic device (IED) 1004 certificate provisioning by allowing an authorized user 1002 and 1004 to retrieve an initial load (provisioning) of identity credentials from the Group Key Distribution Center based on an input of an IED certificate signing request.

IED 1004 key provisioning is supported through a central security management interface 1006 at the GCC. The IED 1004 interacts with the PKI services module 1008 for signing the X.509v3 digital ID credentials v based upon input of the IED 1004 certificate signing request 1004. The IED 1004 provides an interface 1006 for removable media storage of the signed X.509v3 credentials. The following paragraphs outline the process for the provisioning of the CCS-enabled IEDs.

(Generating and) Signing IED X.509v3 Identity Certificates

An X.509v3 certificate signing request and private key is generated by each IED 1004 when it is turned on after the operational software is loaded. If the IED 1004 supports a removable cryptographic flash memory card or cryptographic processor card then at the CCS 100 Central GUI a provisional certificate and private key is generated by the card or by the PKI services module 1008 and the signed certificate 1012 (and private key if needed) is loaded onto the card in one step 1014. The key server maintains the mapping between the signed X.509v3 certificate and each IED 1004 in the database 1010.

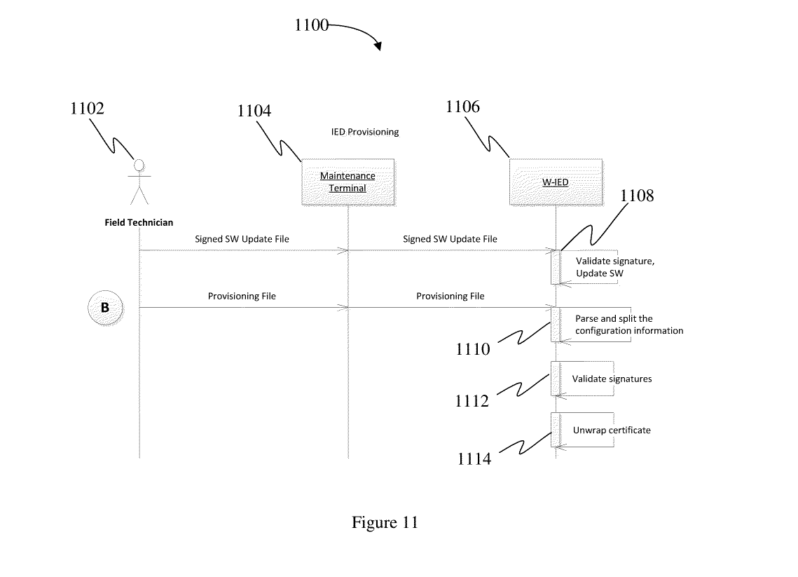

Referring now to FIG. 11, there is shown a diagram of a provisioning sequence 1100 according to one embodiment. Provisioning an IED 1106 begins with an operator 1002 loading the latest operational software image 1108 into the IED 1106 and then loading the IED 1106 signed provisioning file 1110. Loading occurs through the IED's maintenance interface 1104.

If the signed X.509v3 signed certificate was successfully loaded and verified, the IED 1006 now has the information required to register 1112 and 1114 with the field communications services module.

Though the X.509v3 private key is protected, there is the possibility of misuse of the system in an attempt to produce clones. Therefore, the provisioning process should require trusted field technicians 1102, access control protections, and detective controls in place to audit the provisioning activities 1100.

Once the signed X.509v3 certificate (and private key if needed) is loaded, the IED 1106 can be warehoused at the secure depot for a time frame of six months to a year or more.

IED 1106 devices must comply with the applicable protection requirements specified in the Security Requirements Specification For Common Cybersecurity Services (CCS) Edge Security Client (ESC). IED and BES Cyber Asset HWCI devices must store keys within FIPS 140-2 Level 2 or 3 protection boundary.

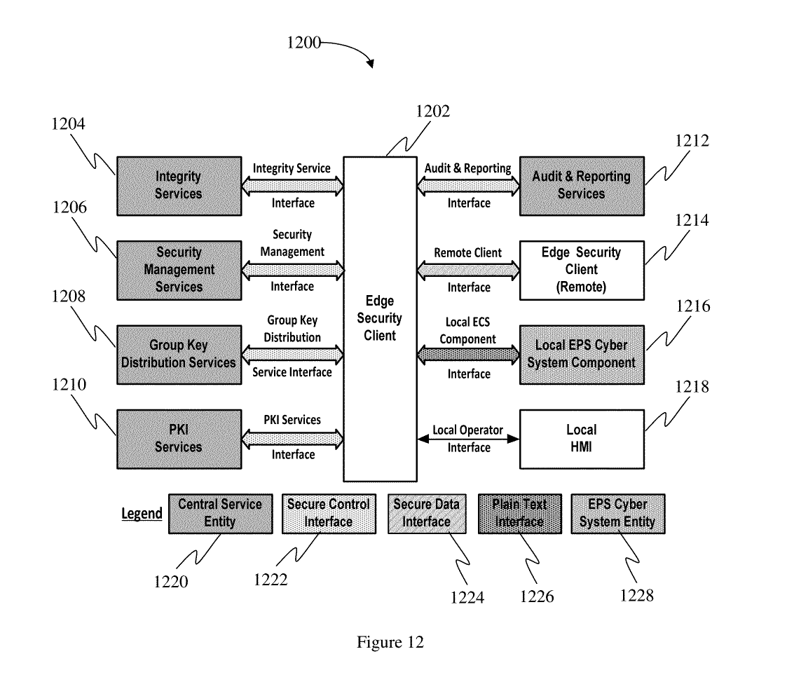

Referring now to FIG. 12, there is shown a diagram of interfaces 1200 between a CCS central services module 1220 and a CCS edge security client 1202. As can be seen, the interfaces 1200 for a central service entity 1220 and an edge security client 1202 comprise an integrity services module 1204, a security services module 1206, a group key distribution services module 1208, a PKI services module 1210 and an auditing and reporting services module 1212. The edge security client also comprises the following interfaces: a remote edge security client services module 1214, a local EPS cyber systems component module 1216 and a local Human Machine Interface (HMI) module 1218.

Each of the interfaces will now be discussed in detail. The identification of each interface includes a project unique identifier and designates the interfacing entities (systems, configuration items, users, etc.). The integrity services interface module 1204 provides the interface used to exchange integrity measurement metrics between the integrity service and the CCS edge security client 1202. The security management services module 1206 interface provides the interface used to configure and control the security services provided by the CCS 100. It is also used to receive status from the CCS edge security client 1202. The group key distribution services module 1208 interface provides the interface used to distribute and manage group keys used to secure internet key exchange (IKE) group domain of interpretation (GDOI) messages. The Public Key Infrastructure (PKI) services module 1210 interface provides the interface used to distribute and manage X.509 Certificates and manage CCS client trust anchors. The audit & reporting services module 1212 interface provides the interface used to receive log and alert information from the CCS edge security client 1202. The remote client interface 1214 provides the interface used to securely transfer data between EPS cyber system applications and EPS cyber system components. The local EPS cyber system component service module 1216 interface provides the interface used to communicate control, status, and data between the local EPS Cyber System Component and the CCS Client. The local operator human machine interface 1218 provides the interface used by a local operator to interface to the EPS cyber system component.

The CCS edge security client 1202 interfaces with the Central Service (CS) entities 1220 over the control plane interfaces and other EPS cyber system components on its secure data plane interfaces 1224. The CCS edge security client 1202 provides the cybersecurity protection for the data transiting both the secure control plane and data plane interfaces 1220, 1222, 1224, 1226 and 1228 via the cybersecurity services.

Integrity Service Interface

The integrity service interface 1204 is used by ECSCs to provide integrity measurement (metrics) to an Integrity Measurement Authority (IMA) using the TNC protocol. The integrity measurement is used by the IMA to verify the integrity of the ECSC, which in turn issues Bill of Health (BoH) Attribute Certificate using the CCS Control Messages via the Data Distribution Service (DDS) protocol. The ECSCs then use the BoH when establishing connections with peers and based upon the state of the BoH (Healthy or Unhealthy) and policy may or may not allow a connection. Additionally, based upon policy, the BoH may contribute to the QoT of the peer.

Security Management Interface

Security management interface 1206 is used to update fielded ECSCs. From the central GUI, an operator can command software/firmware updates, configuration file updates, and command an ECSC to establish an SA with a peer.

Key Distribution Service Interface

The key distribution service interface 1208 comprises a GDOI that extends Internet Security Association and Key Management Protocol (ISAKMP) with new payloads listed in the table below:

| | | |
|---|---|---|
| Identification | ID | Used to identify a group identity that will later be |
| | | associated with security associations for the group. |
| | | A group identity may map to a specific IPv4/6 |
| | | multicast address, or may specify a more |
| | | general identifier. |
| SA | SA | Used by the GKDC to assert security attributes |
| | | for both re-key and data security SAs. In the GDOI, |
| | | the SA payload is directly followed by SA attribute |
| | | payloads. These attribute payloads define specific |
| | | security association attributes for the Key Encryption |
| | | Key (KEK) and/or Traffic Encryption Keys (TEKs) |
| | | used by the group. |
| Nonce | N | The data portion of the Nonce payload must |
| | | be a value between 8 and 128 octets. |
| Delete | D | Used to signal receivers to delete SAs. |

GDOI extends ISAKMP with two new exchanges:

1. GROUPKEY-PULL. An exchange that establishes registration, re-key, and data security protocol SAs. This exchange is initiated by the group member in order to register with a group.

2. GROUPKEY-PUSH. GDOI sends control information securely using group communications. Typically, this will be using IP multicast distribution of a GROUPKEY-PUSH message, but it can also be “pushed” using unicast delivery if IP multicast is not possible. The GROUPKEY-PUSH message replaces a re-key SA KEK or KEK array, and/or it creates a new data security SA. This exchange is initiated by the GKDC.

Note that the GROUPKEY-PUSH message is currently not supported (i.e. “out of scope”) in the 61850-90-5 specification.

PKI Services Interface

The Public Key Infrastructure (PKI) service 1210 provides X509v3 certificates for the CCS. The various types of certificates are used for authentication, secure communications establishment, role based access control, and Bill of Health attestation by both services and clients. Entities trust the communication or information based on the trust of the signer of the certificate—also known as a Trust Anchor. Certificates have a lifetime commensurate with their type of use. Because of certificate expiration, all certificates have to be renewed periodically by the certificate holder. Trust of a certificate can be removed by the revocation process. All relying users of certificates (clients and services) must verify the certificate is not revoked, not expired and signed by the expected trust anchor prior to trusting the transaction (connection or data).

Audit & Reporting Interface

The Audit and reporting services 1212 for the CCS 100 includes events that are categorized as alerts and log entries. Alerts are events in need of attention from an operator. Log entries are alerts and additionally any security relevant event incurred in the system. Several functions within a Client can generate audit messages and alerts may also generate audits. When an alert is sent out over DDS, an audit appears in the Syslog trail so it actually appears in both the LOG and ALERT DDS topic, just more quickly in the ALERT.

Remote EPS Cyber System Component Interface

The Remote EPS Cyber System Component Interface 1216 comprises non-transitory instructions on a computer readable medium for the interface used to securely transfer EPS Cyber System Applications data between EPS Cyber System Components.

Local EPS Cyber System Component Interface

The Local EPS Cyber System Component Interface 1214 comprises non-transitory instructions on a computer readable medium to interface between the Local EPS Cyber System Component and the CCS Client providing the Common Cybersecurity Services.

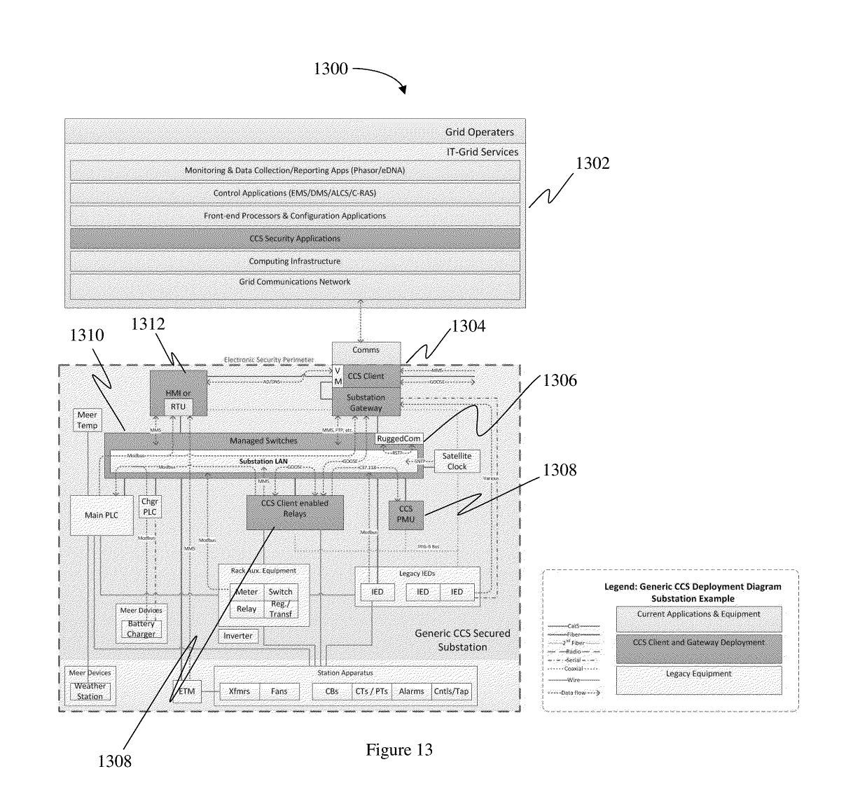

Referring now to FIG. 13, there is shown a diagram 1300 of CCS Protocols. The system 100 is unique in its ability to meet NERC Critical Infrastructure Protection version 5 standards requirements in bulk electric substations and high voltage transmission networks and may also be deployed on utility electric grid distribution systems as well. Specifically, the generic CCS deployment diagram 1300 shows the deployment of CCS central services 1302 and edge service 1304-1314 to protect communication from an electric grid control center to an electric grid substation. The CCS deployment creates an electronic security perimeter via a CCS edge service security gateway 1304 that serves to protect legacy equipment 1312 as well as equipment with CCS edge service capabilities. Communications on the substation LAN are also secured with CCS edge services 1306 as are the CCS enabled Phasor measurement unit 1308, substation relays 1310 and human machine interface 1314 creating a defense in depth approach that would require an attacker to compromise multiple CCS clients with unique cryptographic keys in order to gain full control of the substation.

What has been described is a new and improved system for securing electric power grid operations from cyber-attack, overcoming the limitations and disadvantages inherent in the related art. Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A system for securing electric power grid operations from cyber-attack, the system comprising:
a) a collection of security services distributed throughout a smart grid comprising two main categories:
1) central security services; and
2) edge security services;

2. The system of claim 1, where the central security services integrates security controls and enforcement of security policies through service components deployed centrally at a grid control center and at or near the perimeters of a electric power grid.

3. The system of claim 2, where the central security services comprise non-transitory computer instructions for:
a) security management services;
b) cybersecurity infrastructure services; and
c) automated security services;
where the central security services are physically located at the grid control center.

4. The system of claim 3, where the security management services comprise non-transitory computer instructions for management and configuration of the security services defined by the common cybersecurity services that are distributed throughout the field communications network.

5. The system of claim 3, where cybersecurity infrastructure services comprise non-transitory computer instructions for security infrastructure services defined by the common cybersecurity services.

6. The system of claim 5, where the common cybersecurity services are selected from the group consisting of public key infrastructure, group key distribution services and integrity management.

7. The system of claim 3, where the automated cybersecurity services comprise non-transitory computer instructions for inherent security services that automatically enforce security policy defined for the common cybersecurity services components deployed at the grid control center.

8. The system of claim 7, where the common cybersecurity services components are selected from the group consisting of integrity, availability, and confidentiality.

9. The system of claim 3, where the edge security services comprise non-transitory computer instructions for security configuration services and automated security services that perform distributed enforcement of security policies at or near the perimeters of an electric grid system.

10. The system of claim 9, where the security configuration services comprise non-transitory computer instructions for support configuration of the security services defined by common cybersecurity services and deployed on the cyber assets as the edge of the field communications network.

11. The system of claim 3, where the automated cybersecurity services comprise non-transitory computer instructions for inherent security services that automatically enforce security policy defined for the common cybersecurity services components deployed at the edge.

12. The system of claim 11, where the common cybersecurity services components are integrity and confidentiality.

13. The system of claim 1, further comprising a security domain, a security perimeter or both a security domain and a security perimeter.

14. The system of claim 13, where the security perimeter further comprises one or more than one electronic security perimeter.

15. The system of claim 14, where the electronic security perimeter comprises one or more than one electronic security domains, logically separated from each other by controlled interfaces, trust relationships, and security associations.

16. The system of claim 14, where the electronic security perimeters comprise one or more than one electronic security domains that are logically separated from each other by controlled interfaces, trust relationships, and security associations.

17. The system of claim 16, where the electronic security domains are implemented on critical cyber assets.

18. The system of claim 13, where each domain is segmented by at least one firewall and intrusion detection software native to the common cybersecurity services edge services and controlled interfaces that comprise a security model.

19. The system of claim 18, where the attributes used to define the security model are selected from the group consisting of confidentiality, integrity and availability.

20. The system of claim 19, where the security model comprises non-transitory instructions on a computer readable medium to prioritize security attributes in the following order: (1) availability, (2) integrity, and (3) confidentiality.

21. The system of claim 19, where availability can be measured in subseconds, seconds, minutes, hours, days, weeks and months.

22. The system of claim 18, where integrity for power system operations to provide assurance that data has not been modified without authorization.

23. The system of claim 18, where confidentiality is comprised of privacy of customer information; electric market information; and general corporate information.

24. The system of claim 3, where the common cybersecurity services comprise non-transitory instructions on a computer readable medium for security controls to interface with external smart grid security domains.

25. The system of claim 24, where the external smart grid security domains are selected from the group consisting of WECCnet, NASPInet, and Public Information Systems.

26. The system of claim 3, where cyber security infrastructure services comprise a central security service, a security information repository and PKI services module.

27. The system of claim 26, where the security information repository module comprises a security database and an audit log collector.

28. The system of claim 26, where the PKI services module comprise non-transitory instructions on a computer readable medium for:
a) executing and issuing X.509 identity certificates for use in communication authentication;
b) receiving certificate requests from clients;
c) sending certificate responses to clients; and
d) managing and controlling trust anchor updates to all assets.

29. The system of claim 26, where the central security services module further comprises:
a) a security configuration management service module;
b) an integrity service module;
c) a group key distribution service module; and
d) an automated security services module.

30. The system of claim 29, where the security configuration management service module comprises:
a) an asset management module for maintaining the electronic serial number association with each cyber asset; managing updates each cyber asset configuration, including upgrades of software or configuration files; and removing Cyber Assets from the network;
b) A policy Management module for managing the creation or alteration of the policies under which the system operates; management and distribution of cyber asset security policies; Role-Based Access Control (RBAC) policy for the cyber asset; electronic access control or monitoring systems policy; and physical access control systems policy;
c) a network management module for managing IP address assignment for each cyber asset; segmentation of the network to minimize compromise; electronic access control systems; and electronic security perimeter gateway policy; and
d) a group management module that manages the creation and deletion of communications groups and assignment or removal of cyber asset into or out of groups; Role management for assigning or changing the role(s) of each cyber asset; security management interface which provides the graphical user interface (GUI) for the security configuration management functions (also called the central security GUI within this document).

31. The system of claim 30, where the network management module can be an interface to an existing network management system.

32. The system of claim 26, where the security configuration management service module comprises non-transitory instructions on a computer readable medium for configuring the security services provided by the common cybersecurity services.

33. The system of claim 26, where the security configuration management service module further comprises non-transitory instructions on a computer readable medium for an asset management for maintaining an electronic serial number association with each cyber asset; managing updates of each cyber asset configuration, including upgrades of software or configuration files; and removing cyber assets from the network.

34. The system of claim 26, where the security configuration management service module further comprises non-transitory instructions on a computer readable medium for policy management for managing the creation or alteration of policies that the system operates; management and distribution of cyber asset security policies; role-based access control (RBAC) policy for cyber assets; electronic access control or monitoring systems policies, and physical access control systems policies.

35. The system of claim 26, where the security configuration management service module further comprises non-transitory instructions on a computer readable medium for network management that manage IP address assignment for each cyber asset, segmentation of the network to minimize compromise, electronic access control systems, and electronic security perimeter gateway policies.

36. The system of claim 30, where the network management module can be an interface to an existing network management system.

37. The system of claim 30, where the security configuration management service module comprises instructions for a graphical user interface.

38. The system of claim 29, where the security configuration management service module comprises non-transitory instructions on a computer readable medium for asset management, security policy management, and identification and authentication management.

39. The system of claim 38, where the security configuration management service module are an integrated tool set with a common integrated security management interface.

40. The system of claim 38, where the security configuration management service module are discrete applications.

41. The system of claim 29, where the asset management module comprises non-transitory instructions on a computer readable medium for centralized configuration management and change control for all common cybersecurity services registered and controlled cyber assets.

42. The system of claim 29, where the asset management module comprises non-transitory instructions on a computer readable medium to maintain security configuration baselines on all clients, servers, and network devices that have been registered.

43. The system of claim 29, where the central security services module comprises a database describing the desired configuration data for each commercial platform that is supported.

44. The system of claim 29, where the asset management module further comprises non-transitory instructions on a computer readable medium for vulnerability assessment in order to evaluate all components of the system for security vulnerabilities and for compliance with its maintenance and security policies.

45. The system of claim 29, where the security policy management module comprises non-transitory instructions on a computer readable medium for automated policy management tools to create, review and approve policies.

46. The system of claim 29, where the integrity service module comprises non-transitory instructions designed to boost integrity, trust and non-repudiation of all cyber assets participating in smart grid applications.

47. The system of claim 29, where the integrity service module comprises non-transitory instructions on a computer readable medium that define requirements for cyber assets to use integrity measurement to prove their integrity to each other and to an integrity management authority.

48. The system of claim 29, where the integrity service module comprises non-transitory instructions on a computer readable medium to interface with cyber assets that are responsible for detection of modifications to their code and configuration, determination of the state of their code and configuration, demonstrating to the integrity service module that their code and configuration are in a known-good state and demonstrating their integrity to each other by presenting a bill of health certificate issued by the integrity service module.

49. The system of claim 29, where the integrity service module 404 stores records for all the registered cyber assets that it has performed attestation with, recording client identity, a timestamp, the result of attestation including reason for failure)if applicable), the Bill of Health serial number if one was issued, and the Bill of Health validity period. The integrity service module 404 uses the Trusted Computing Group Trusted Network Connect standards to perform attestation with the Edge Security Clients.

50. The system of claim 29, where the group key distribution service module comprises non-transitory instructions on a computer readable medium for creating and maintaining group keys used to secure Internet Key Exchange (IKE) Group Domain of Interpretation (GDOI) messages for multicast communications.

51. The system of claim 29, where the group key distribution service module comprises at least one computer running non-transitory instructions on a computer readable medium for application level software and a hardware cryptographic module comprises non-transitory instructions on a computer readable medium for cryptographic algorithms.

52. The system of claim 29, where the group key distribution service module comprises key management primitives to:
a) generate, derive and wrap keys;
b) broadcast current key generation messages;
c) respond to group join requests;
d) perform compromise recovery;
e) perform initiated key replacements; and
f) securely wrap keys for storage in a security database.

53. The system of claim 29, where the automated security services module comprises non-transitory instructions on a computer readable medium for core cryptographic services.

54. The system of claim 29, where the automated security services module comprises non-transitory instructions on a computer readable medium for confidentiality, integrity, authentication, and key management cryptographic services.

55. A method for securing electric power grid operations from cyber-attack, the method comprising the steps of:
a) loading the latest operational software image into an intelligent electronic device;
b) loading the intelligent electronic device signed provisioning file, where the loading occurs through the intelligent electronic device's maintenance interface;
c) registration with a field communications services module if the signed X.509v3 certificate was successfully loaded and verified; and
d) warehousing the intelligent electronic device at a secure depot for a time frame of six months to a year or more.

56. The method of claim 55, further comprising the step of auditing access control protections and detective controls.

57. The method of claim 55, further comprising the step of warehousing the intelligent electronic device at a secure depot for a time frame of six months to a year or more.
